(19) United States
(12) Patent Application Publication
(10) Pub. No.: US 2015/0221238 A1
(43) Pub. Date: Aug. 6, 2015

(54) SYSTEMS AND METHODS FOR PROVIDING HEMORRHAGE CONTROL TRAINING

(71) Applicant: Z-Medica, LLC, Wallingford, CT (US)

(72) Inventor: Robert Huebner, Wallingford, CT (US)

(21) Appl. No.: 14/643,689

(22) Filed: Mar. 10, 2015

Related U.S. Application Data
(63) Continuation of application No. PCT/US2013/060915, filed on Sep. 20, 2013.
(60) Provisional application No. 61/704,379, filed on Sep. 21, 2012.

(51) Int. Cl. G09B 23/30

(52) U.S. Cl. CPC G09B 23/30

(57) ABSTRACT

Embodiments of a task monitoring system for hemorrhage control provide real-time or near real-time feedback to a trainee on the force that the trainee is applying to a simulated wound. In some embodiments, the task monitoring system comprises a mobile device, a pressure sensor, and a software application (“app”) that runs on the mobile device. The task monitoring system allows the trainee (e.g., medic, doctor, nurse, or other health worker) to practice applying the correct force on simulated wounds over defined time periods, training muscle memory of the health service provider to apply the correct pressure over the correct time duration.

### CROSS REFERENCE TO RELATED APPLICATIONS

This application is a continuation of International Application No. PCT/US2013/060915, filed on Sep. 20, 2013, which claims the benefit of priority to U.S. Provisional Patent Application No. 61/704,379, filed Sep. 21, 2012. The foregoing applications are fully incorporated herein by reference in their entireties for all purposes.

### BACKGROUND OF THE INVENTION

1. Field of the Invention

The present invention relates generally to training devices, and more particularly to devices for training users to perform physical actions.

2. Description of the Related Art

In daily life, people perform many physical tasks that require specific movements and procedures. In some cases, these tasks involve certain techniques that must be learned over time to enable a person to consistently perform the tasks well. In some situations, it can be difficult to train people in certain tasks because critical factors, such as human injury or high monetary costs, may be at risk each time the tasks are performed, even in training exercises. Errors performed during training can be extremely regrettable. To diminish this risk, training simulations can help a person develop the skills to perform a task before the real task is performed for the first time, or can help a person to improve the skills involved in a task on an ongoing basis.

In one example, a task that may require specific training is the proper treatment of a severely bleeding wound. In a wide variety of circumstances, animals, including humans, can be wounded. Bleeding is often associated with such wounds. In some circumstances, the wound and the bleeding are minor, and all that is required is the application of simple first aid and the normal blood clotting function of the body. Unfortunately, in other circumstances substantial bleeding can occur. These situations may require specialized equipment and materials, as well as personnel trained to administer appropriate aid. If such aid is not readily available, excessive blood loss can occur. Moreover, severe wounds can often be inflicted in remote areas or in situations such as on a battlefield, where adequate medical assistance is not immediately available. In these instances, it can be very useful for personnel to be trained to stop the bleeding, even in less severe wounds, long enough to allow the injured person or animal to receive serious medical attention.

### SUMMARY OF THE INVENTION

Training devices and systems can include a first contact portion on which a trainee performs one or a plurality of physical actions that can be measured or graded using one or a plurality of criteria, and a second feedback portion that provides information regarding the physical action performed by the trainee. In some embodiments, simulation systems can include a contact portion in the form of a simulated item on which a simulated task is performed, such as a life-size human body manikin or a body-part manikin or moulage. Simulated items can include features such as joint mobility for easy positioning in various environments. In some embodiments, a wound simulator can replicate a wide range of real trauma conditions that are likely to confront the rescuer and can be used for demonstrating and teaching proper first aid techniques.

According to some embodiments, a task monitoring system for hemorrhage control can be placed into communication with the simulated item to provide real-time or historical feedback to a trainee regarding one or more aspects of performing blood stanching properly. For example, in some embodiments, feedback can be provided to the trainee on the force and/or time that the trainee is applying to a simulated wound. In some embodiments, the task monitoring system comprises a mobile device, a pressure sensor, and a software application (“app”) that runs on the mobile device. The mobile device can be configured to receive pressure data from a pressure sensor. The app can read the pressure data from the pressure sensor and can graphically display the force and/or time on the screen, providing graphical feedback, and/or audio feedback, or other indications to the trainee on the proper pressure and/or timing used to apply a dressing, compression bandage or other hemostatic material to a wound. All references to the capabilities, features, and/or logic structure of an app described herein can apply to any other type of computer or electronic processing system, including but not limited to a desk-top or lap-top computer or an onboard processing device in a simulation system.

The task monitoring system can provide trainees with valuable feedback on the proper procedures for controlling bleeding. A common method to control bleeding is to place a dressing on a bleeding wound and then apply manual compression over the dressing for sufficient time. This may be done in clinical settings (e.g., in hospitals and or other treatment facilities) as well as other settings such as in the field (e.g., on a battlefield or in an ambulance), or other emergency care settings. Different wound types can require different levels of manual pressure and compression time. If the force is too light, then the risk of not controlling the bleeding is higher. If the force is too high and/or applied for too long, it could cause complications such as artery occlusion, which is a blood clot in the artery.

It can therefore be useful to train caregivers in the proper technique for controlling various types of bleeding on various types of wound types with the appropriate amount of force over various time durations. Feedback-based training methods can develop the caregiver's muscle memory to maintain the correct force over a certain time duration. Embodiments of the task monitoring system described herein can allow the caregiver to practice applying the an appropriate amount of force on simulated bleeding wounds over defined time periods, to teach the trainee how to apply the correct pressure over the correct time duration.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 illustrates an embodiment of a task monitoring system (TMS) for monitoring force applied by a trainee over time on a simulated wound site.

FIG. 2 illustrates an example of using the task monitoring system of FIG. 1 with a simulated body part.

FIG. 3 schematically illustrates an example of a logical flow diagram for a monitoring process to monitor the pressure applied over time by the trainee on the simulated wound site.

FIG. 4 schematically illustrates a logical flow diagram for a training process for the trainee to learn correct techniques for hemorrhage control.

FIG. 5 shows an example of a contact portion or simulated item with a feedback portion integrated into it.

### DETAILED DESCRIPTION

A training system can provide trainees with valuable feedback on the proper procedures for performing tasks. In some examples, a task monitoring system allows a health service provider (e.g., medic, doctor, nurse, or other health worker) to practice applying the proper force range on simulated bleeding wounds over particular time periods, training the health service provider to apply the correct pressure range over a correct time interval.

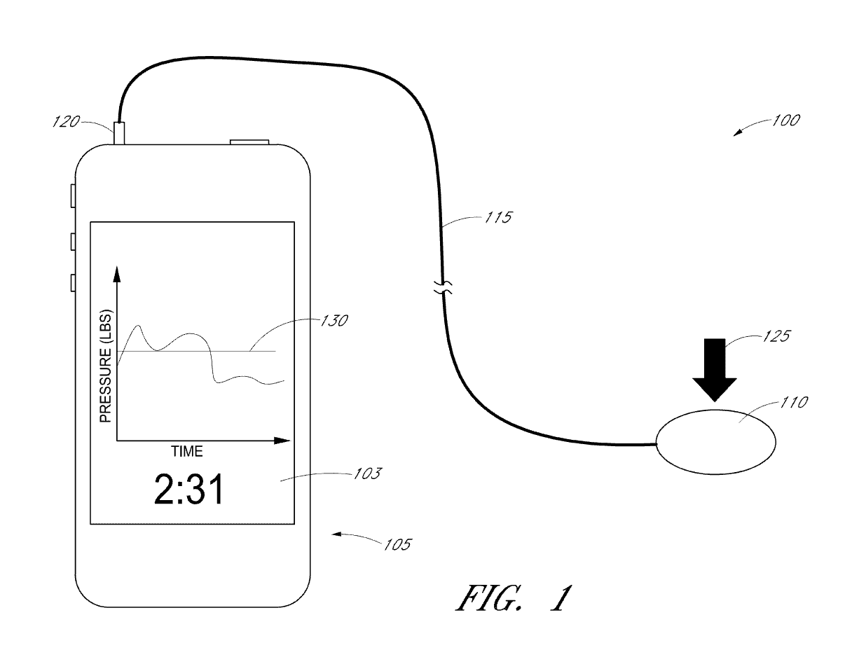

FIG. 1 illustrates an embodiment of a task monitoring system (TMS) 100 for monitoring force applied by a user on a simulated wound site. The task monitoring system 100 can include a computing device comprising one or more processors and computer memory, a pressure sensor 110, a communication link 115 between the pressure sensor and the computing device, and a pressure signal receiver 120 for receiving an electronic signal that includes pressure data from the pressure sensor.

In some examples, the task monitoring system 100 can be used for training a user or trainee in proper techniques for stopping wounds from bleeding. Generally, different wounds can require different amounts of force and/or the application of force for different lengths of time. In some cases, the level of force for a wound may require change over time. For example, greater force may be required when first attempting to stop bleeding from a wound but the required force may lessen as the bleeding slows. Thus, the task monitoring system 100 can be used to train the trainee in the correct levels of force (including a changing force), and/or a time duration. In some types of wounds, such as the access site on the wrist following radial access for percutaneous coronary intervention, a proper amount of force applied to a wound can be at least about one pound of force (4.4_newtons) and less than about ten pounds of force (44 newtons).

In the illustrated embodiment, the computing device is a mobile device 105 (e.g., smart phone, tablet, etc.) capable of running applications 103. The mobile device can comprise a video display screen and a portable power source. In some embodiments, the mobile device 105 includes the pressure signal receiver 120 for receiving pressure data. In some embodiments, the pressure signal receiver 120 comprises an audio port on the mobile device that is repurposed to receive pressure data. In some embodiments, the pressure signal receiver 120 comprises a digital connector technology, such as Universal Serial Bus (USB), FireWire, etc.

In some embodiments, the sensor 110 sends the pressure data serially using an analog signal to the audio port on the mobile device. Some audio ports can have filters on the input that block frequencies that are too high. Thus, in some embodiments, the analog signal is band-limited so that high frequencies are not used.

In some embodiments, the audio part can be a tip ring sleeve (TRS) or similar connector. A TRS connector refers to a family of connectors typically used for analog signals, including audio. It is generally cylindrical in shape, and it has a plurality of separate electrical contacts (e.g., typically three contacts, although variations with two contacts (a TS connector) or four contacts (a TRRS connector) can be used). A TRS jack generally fits into a TRS socket. For a three-contact TRS connecter, the three contacts typically map to the left audio channel, the right audio channel, and ground. Many mobile phones use a TRRS connector with four contacts, which maps to left, right, and ground, with a fourth connector that maps to a microphone. Connecters are available in a variety of sizes, such as 2.5 mm (e.g., used by some mobile phones to save space), 3.5 mm (e.g., for phones, mp3 player, etc.) and 0.25″ (e.g., for larger headphones, guitars, etc).

In some embodiments, the communication link 115 comprises a wired connection between the pressure sensor 110 and the pressure signal receiver 120. For example, one end of the wire can be a TRS jack that fits into an audio port and the other end of the wire terminates at a data interface with the pressure sensor 110. Data received from the pressure sensor 110 at the data interface is then transmitted on the wire and into the audio port as an electronic signal. In some embodiments, the electronic signal carries pressure data, including compression force levels measured at a wound site. Depending on the embodiment, the electronic signal may be analog or digital. In some embodiments, the communication link 115 is a wireless connection, such as Bluetooth, 802.11a/b/g/n, infrared, radio, or other type of connection.

In some embodiments, the contact portion or simulated item can comprise one or more transducers that create electrical signals from physical actions. An example of a type of transducer is a pressure sensor 100. In some embodiments, the pressure sensor 110 comprises one or a plurality of electrical devices for measuring pressure on a surface, such as a load cell. Load cells are typically inexpensive, thereby keeping down the cost of the task monitoring system 100. Generally, a load cell is a transducer that is used to convert a force on the load cell into an electrical signal. Typically, this conversion is indirect and happens in two stages. For example, through a mechanical arrangement, the force being sensed by the load cell can deform a strain gauge. The strain gauge can then measure the deformation (strain) as an electrical signal, because the strain changes the effective electrical resistance of the wire.

Generally, a strain gauge (also referred to as a strain gage) is a device used to measure the strain placed on an object. In some embodiments, a strain gauge includes an insulating flexible backing which supports a metallic foil pattern. The gauge can be attached to the object by a suitable adhesive, such as cyanoacrylate, epoxy, acrylic glue or the like. As the object is deformed, the foil is deformed, causing its electrical resistance to change. When an electrical conductor is stretched within the limits of its elasticity such that it does not break or permanently deform, it becomes narrower and longer, causing an increase in its electrical resistance end-to-end. Conversely, when a conductor is compressed such that it does not buckle, it broadens and shortens, causing a decrease in its electrical resistance end-to-end. By measuring the electrical resistance of the strain gauge, the amount of applied stress can be inferred from the electrical resistance.

In some embodiments, the load cell includes four strain gauges in a Wheatstone bridge configuration, though other electrical circuit configurations are possible. For example, load cells with one strain gauge (e.g., a quarter bridge) or two strain gauges (e.g., a half bridge) are also possible. The electrical signal output from a load cell is typically in the order of a few millivolts and may require amplification by an instrumentation amplifier. In some cases, load cells with higher power outputs may be used. In some embodiments, an application or other process on the mobile device 105 receives the electrical signal output from the load cell and calculates the pressure applied on the load cell based at least partly on the strength of the electrical signal. Other types of load cells may also be used. Some examples of other load cell types are hydraulic or hydrostatic load cells, piezoelectric load cells, vibrating wire load cells, and capacitive load cells.

Furthermore, other types of pressure sensors can also be used. Some examples of pressure sensors include piezoresistive strain gauges (of which load cells are one possible type), capacitive pressure sensors, electromagnetic pressure sensors, piezoelectric pressure sensors, optical pressure sensors, potentiometric pressure sensors, resonant pressure sensors, thermal pressure sensors, ionization pressure sensors, or the like. The pressure sensor 110 can include one or more of the different pressure sensor types, including combinations of different pressure sensor types. In some embodiments, the pressure sensor includes a power source, such as a portable electrical power source.

Force 125 applied to the pressure sensor 110, causes an electronic signal to be generated by the sensor 110 and transmitted to the mobile device 105. In some embodiments, an application 103 on the mobile device processes the electronic signal to determine the current pressure being applied by the pressure sensor 110. The application can then compare this current pressure with a target pressure 130 that is pre-set or otherwise defined for the application. The application can determine the current pressure for an instant, for multiple instants, or generally continuously over a period of time. In some embodiments, the current pressure is determined continuously and compared continuously to the target pressure 130. In some embodiments, if the application determines that the current pressure varies or deviates from the target pressure, it signals such a deviation to the trainee so that the trainee can modify the pressure the trainee is applying. Various signals can be used, such as visual, auditory or physical cues. For example, the mobile device can generate an auditory or tactical indicator, such as an alarm, a flash or other visual cue on the screen, a vibration, or some other human-perceptible signal.

In this example, by signaling to the trainee in real time or near real time, the application beneficially creates a feed-back loop that informs the trainee when he or she is or is not applying the proper amount of pressure. In some embodiments, the application only generates a signal when the deviation is greater than a particular threshold, and in some embodiments the application generates a signal displaying all pressure readings over a period of time.

In some embodiments, the mobile device 105 includes a display screen that comprises at least part of a feed-back loop for a user. The display screen can show a chart of pressure (e.g., along a vertical or “Y” axis) and time (e.g., along a horizontal or “X” axis). In some embodiments, the display screen is a touch screen capable of receiving user inputs, such as the target force. During training, the user can observe the deviation, if any, between the compression force being applied by the user and the target force over time. With repeated practice, the user can develop muscle memory to control various bleeding wound simulations appropriately. The user can learn to adjust to fatigue and maintain the right force for the required time.

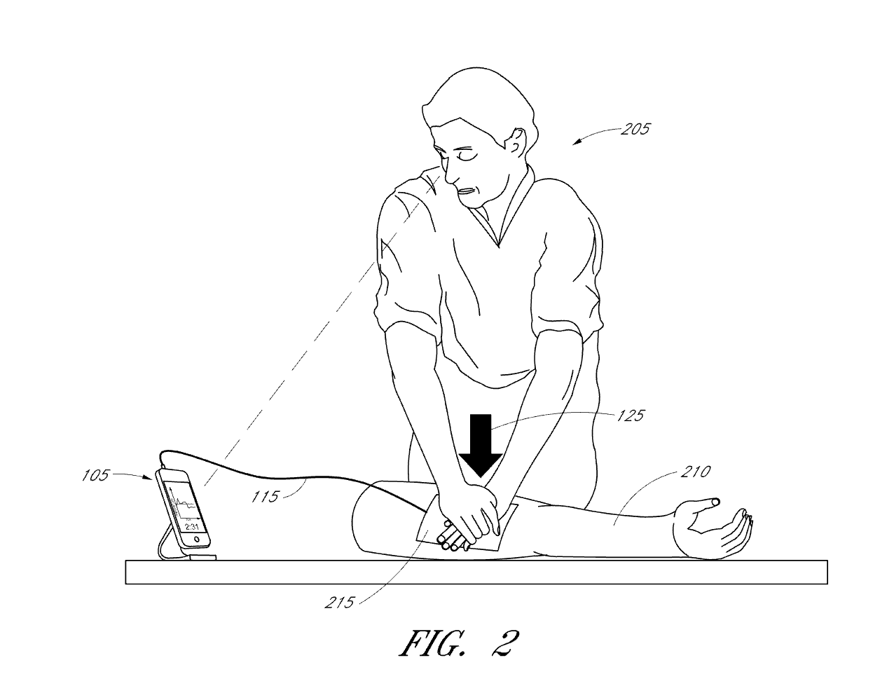

FIG. 2 illustrates the usage of an example of the task monitoring system 100 of FIG. 1. In this example, a trainee 205 is using the task monitoring system 100 to learn the proper techniques for hemorrhage control of various wounds. In FIG. 2, the trainee 205 applies pressure on a simulated wound while being monitored by the TMS 100. The pressure applied to the wound site and monitored by the TMS can be continuous or pulsed pressure.

In the illustrated embodiment, the task monitoring system 100 is incorporated into or operated with a wound simulator 210 (e.g. a moulage or manikin). In some embodiments, the sensor 110 is attached to the wound simulator at a simulated wound site 215. The sensor 110 can be located in a variety of locations, such as within the wound simulator, under the wound site, on top of the wound site or the like. Many different types of wound simulators can be used, such as partial body models (e.g., arms or legs), full-body manikins, wound models for placement on real humans or animals for a more realistic simulation, makeup or the like. In some embodiments, the sensor 110 can include a plurality of sensing units to enable the sensor 110 to indicate not only an amount of applied forces but also where in a given area a force, or multiple forces, are applied. This can assist in determining whether a trainee is positioning his or her hands appropriately and/or otherwise pushing in the right places.

In some embodiments, an assembly comprising a sensor 110 can be removably positioned directly on or near a body part such as by using a sticker, suction cup, strap, or other temporary retention device, either for simulations or for use in actual blood-stanching activities to help ensure that a proper range of compression force is applied for a therapeutically effective range of time. A sensor 110 in some applications can be sufficiently thin to fit between the folds of a bandage being applied to a real bleeding wound. The sensor 110 can be disposable or can be provided with a disposable covering.

In some embodiments, the task monitoring system 100 provides training for a variety of wound types that require different levels of pressure and/or time. For example, the application 103 on the mobile device 105 can include a selection screen for selecting or specifying wound-related parameters, such as the size, location, blood flow and/or type of the wound. Based on these parameters, the application 103 can select the target pressure and/or time for the wound. In some embodiments, the application 103 allows a user to select or provide the target pressure and/or time directly by specifying the target values. In other embodiments, distinct applications or devices are created for various wound types such that each particular wound type application or device has a pre-set target pressure and/or time for the particular wound.

In the illustrated example, the trainee 205 is training in the proper technique for a particular wound type. A mobile device 105 is configured to monitor the trainee and determine whether the trainee 205 is applying pressure at the target pressure level and/or for the target time. The mobile device 105 can be placed on a stand, attached to a surface or mount, or otherwise configured such that a display of the mobile device 105 is viewable by the trainee or by a teacher or both. As the trainee applies force 125 at the simulated wound site 215, the pressure sensor at the wound site sends an electronic signal (e.g., via a wire 115 or other communication link) to the mobile device 105, the signal including pressure data. The mobile device 105 can determine the current pressure level from the pressure data. The mobile device 105 may also track instantaneous pressure level readings over time.

In some embodiments, the mobile device 105 provides a graph or other data representation of the pressure level readings on its display, so that the trainee or a teacher, or both, can see the data presentation in real time, after the training is complete, or both. For example, the current pressure line on the graph can move above the target pressure line 130 if the current pressure is too high or below the target pressure line 130 if the pressure is too low. In some embodiments, a first symbol (e.g., an “up” arrow) can direct the trainee to apply less pressure and a second symbol (e.g., a “down” arrow) can direct the trainee to apply less pressure, and a third symbol can indicate to the trainee that the amount of pressure is about right.

In some embodiments, the app can also provide advice and instructions about how to perform a task or how to perform a task in a better way. Instructions can be provided in a series manner as certain tasks are completed, or can be accessed by a user or trainee in any order for review. In some embodiments, appropriate instructions can be given as needed to help a trainee correct an action or clues or hints can be provided to assist a trainee in recalling certain steps. The instructions can also be accessed when performing the actual task (rather than a simulated version of the task). In some embodiments, the instructions or feedback can be read or announced to the trainee in an audible voice by the processor to avoid districting the trainee, since the trainee's eyes may be focusing primarily on performing the task.

By providing the trainee with feedback on whether he is applying the proper pressure, the trainee is better able to learn the proper technique for the wound. Furthermore, additional or alternative forms of feedback can be provided to the trainee to indicate when the trainee is deviating from the proper technique. As discussed above, user feedback can include visual, auditory or physical cues that can indicate proper or improper technique. In some embodiments, such cues are based at least partly on the degree of deviation from the target values (e.g., time and/or pressure). For example, the mobile device 105 may vibrate or emit a tone or other sound that increases in strength based on the deviation from the target values, such that the trainee is encouraged to apply the proper technique in order to minimize the emitted sound. In another example, the mobile device 105 display may begin to blink more rapidly or may progressively display different levels or brightness and/or different colors (e.g., green, orange, red, etc.) as the trainee deviates further from or closer to the target values. In another example, the pressure sensor can include a buzzer or vibration device such that the trainee is given physical feedback (e.g., via his hands on the wound) that increases or decreases based on the level of deviation or proximity.

By providing cues that are based at least partially on the level of deviation from or proximity to target values, the task monitoring system 100 can provide the trainee with an indication of the amount of corrective action that the trainee needs to take. For example, the trainee would know to press harder or ease off more on the pressure on the wound site 215 if the cue indicates a high deviation compared to if the cue indicates a low deviation. Thus, the trainee can more quickly return to the proper technique.

In some embodiments, the task monitoring system 100 provides cues that are based at least partly on whether the trainee is applying too much pressure or too little pressure. For example, if too little pressure, the mobile device 105 display may flash red while, if too much pressure, the display may flash blue. In another example, different sounds are played depending on whether the pressure is too low or too high. In another example, different vibration pattern are used depending on whether the pressure is too low or too high.

In some embodiments, the target value used by the task monitoring system 100 is a range of values rather than a single value. For such embodiments, the task monitoring system 100 may only provide a particular cue when measured values fall outside the ranges of the target values.

The task monitoring system 100 can track the pressure applied by the trainee over time. After a certain amount of time, the trainee finishes applying pressure for the amount of time required by the particular technique and the training session ends. In some embodiments, the mobile device 105 indicates to the trainee that the session has ended through a cue (e.g., visual, auditory, physical, etc.). If the trainee wishes to practice the technique again, the trainee can restart the training session. In some embodiments, the mobile device 105 may automatically start a new training session until a specified amount of sessions are completed. For example, training sessions may be repeated 2, 3, 4 or more times in order to develop the trainee's muscle memory. In some embodiments, the mobile device 105 pauses between sessions to provide a break to the trainee. In some embodiments, the proper time is not revealed to the trainee until after the end of each simulation to permit the trainee to learn to estimate mentally when the right amount of time has passed. In some embodiments, the trainee or instructor can switch between settings in the app to display the time as it elapses or only after a simulation is completed, depending on whether the trainee is still learning the proper time duration or has already learned the proper time duration and is seeking to test his or her estimating skill without viewing the passing time.

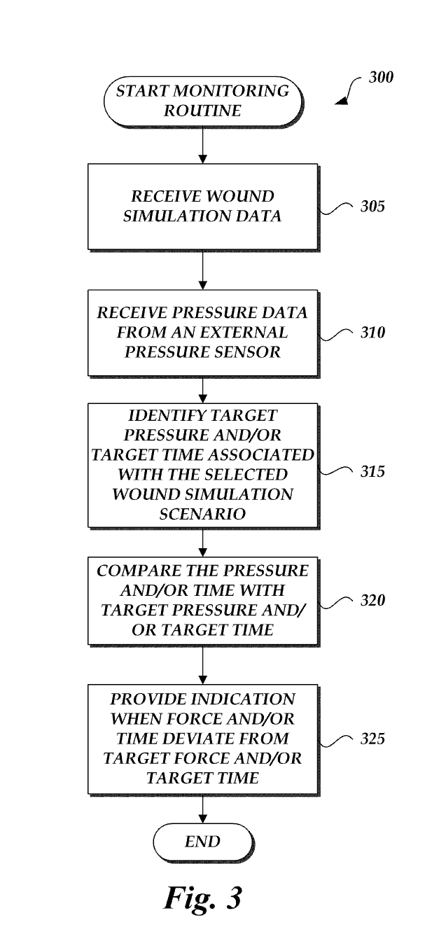

FIG. 3 schematically illustrates a logical flow diagram for a monitoring process 300 to monitor the pressure applied by a user to a wound simulator. In some implementations, the process is performed by embodiments of the task monitoring system 100 described with reference to FIG. 1 or by another a component of the system 100, such as the mobile device 105 or an application 103 operating on the mobile device 105. For ease of explanation, the following describes the process as performed by the mobile device 105. The process is discussed in the context of an example that is intended to illustrate, but not to limit, various aspects of the task monitoring system 100.

Beginning at block 305, the mobile device 105 receives wound simulation data, such as a selection of one of a plurality of wound simulations or some other simulation parameters. In some embodiments, the mobile device 105 includes settings for a variety of scenarios for different wound types. The mobile device 105 can provide a user with a selection screen in which the user can select a particular training situation. In some embodiments, the mobile device 105 allows the user to input simulation parameters, such as the target force to apply and/or the target time for the pressure to be applied. In some cases, the system can be configured so that the user may train in the correct force to apply and only provide a target force. In some cases, the user may train in the correct time to apply force and only provide a target time. In some cases, the user may train how to apply the correct force for the correct amount of time and provide both the target force and the target time. The mobile device 105 can store these values (e.g., force and/or time) in memory for future reference.

At block 310, the mobile device 105 receives pressure data from a pressure sensor 110. As discussed above, the pressure data can be received through a communication link, such as a wired or wireless link. At block 315, the mobile device 105 identifies the target pressure and target time associated with the selected type of wound simulation. The target pressure and target time may be pre-set parameters associated with the scenario or may have been entered into the mobile device by the user. At block 320, the mobile device 105 compares the measured pressure and/or the time the pressure has been applied with the target pressure and/or the target time. At bock 325, the mobile device 105 provides an indication when force and/or time deviate from the target force and/or target time. In some embodiments, the mobile device 105 provides a cue when the values deviate from the target. The process may then end.

In some cases, the mobile device 105 records data from the training session, which can be used for the future reference of the user. For example, the mobile device 105 can use the data to generate a report on how closely the user met the target values. In some embodiments, the mobile device 105 can generate a score that indicates how closely the user met the target values. The app can also aggregate data from multiple users to permit a training instructor to identify trends that may influence teaching approaches. The app may also be configured to receive and store identifying data regarding a trainee (e.g., name and/or personnel number) and communicate such information to a computer system regarding a particular person's success or failure in certifying competence in performing a particular simulated task or series of tasks.

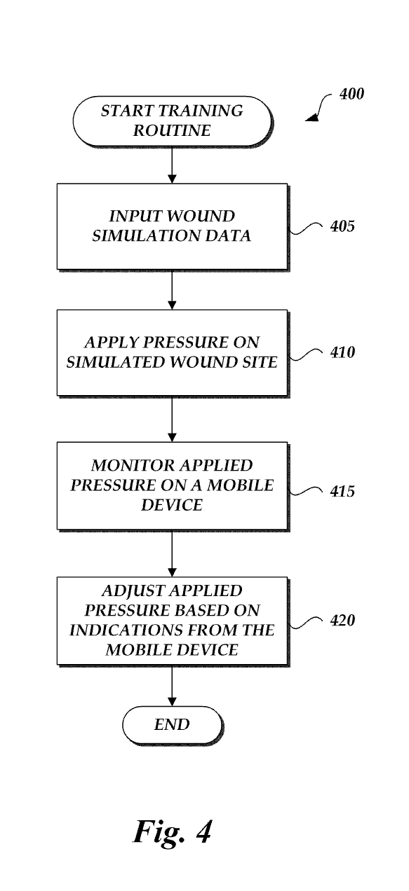

FIG. 4 schematically illustrates a logical flow diagram for a training process 400 for a user to learn correct techniques for hemorrhage control. In some implementations, the process is performed by a user of the task monitoring system 100. For ease of explanation, the following describes the user as interacting with the mobile device 105 of the task monitoring system 100, however, in other embodiments, the user may be interacting with other components of the task monitoring system 100. The process is discussed in the context of an example scenario that is intended to illustrate, but not to limit, various aspects of the training process.

Beginning at block 405, the user inputs wound simulation data into the mobile device 105 of the task monitoring system 100, such as a selection of a wound simulation scenario or simulation parameters. The mobile device 105 can store these parameter values (e.g., force and/or time) in memory for future reference. At block 410, the user applies pressure on a simulated wound site on a wound simulator. In some embodiments, a pressure sensor at the wound site sends pressure data to the mobile device 105. At block 415, the user monitors the applied pressure he is applying to the wound site via the mobile device 105. For example, the mobile device 105 may display a graph or provide other indications of how closely the applied pressure matches the target values. At block 420, the user adjusts the applied pressure based at least partly on indications from the mobile device 105. For example, the mobile device 105 may provide auditory, visual, or physical cues to indicate if the user is deviating from the target values and/or the degree to which the user is deviating, thereby creating a feed-back loop for the user. The user can adjust the pressure he is applying according to such indications. The indications may be provided directly by the mobile device (e.g., on a built-in display or speaker) or indirectly (e.g., on an external display, speaker or vibration device). After a defined time, the training session may end. In some cases, the user may repeat the process in order to receive additional training.

Many versions of the task monitoring system 100 can be used. For example, while this disclosure has generally described the system 100 as including a mobile device 105, in some embodiments the task monitoring system 100 includes a desktop computer, terminal or other stationary computing device that performs functions similar to the mobile device 105.

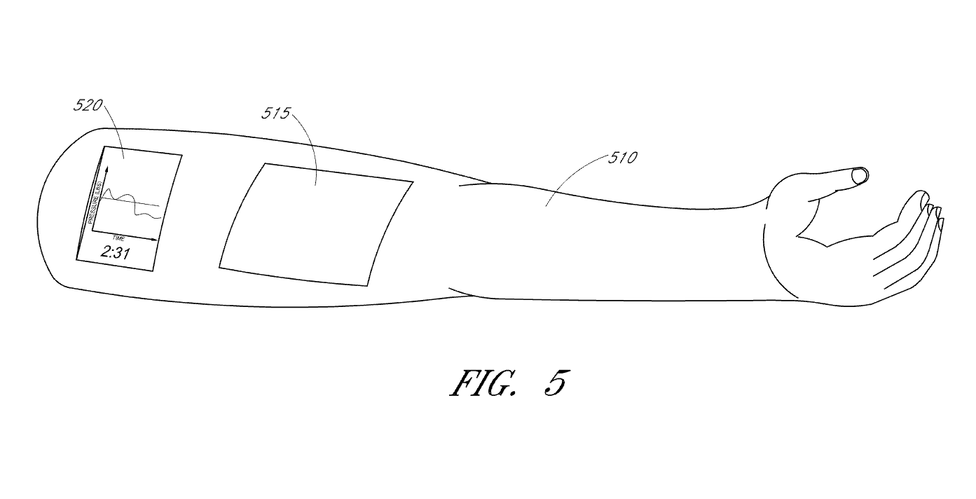

FIG. 5 illustrates an embodiment of a task monitoring system that is built into or integrated on or within a wound simulator 510. For example, as illustrated in FIG. 5, the wound simulator 510 can include a computing device and a display 520 that performs functions similar to the mobile device 105 of FIG. 1. The computing device can be in communication with a pressure sensor, which may be located at a simulated wound site 515.

In some embodiments, the wound simulator can be configured to simulate blood flow from a wound (such as by emitting a red-colored liquid) and the task monitoring system 100 can be configured to control the blood flow in response to the amount of pressure applied by a trainee. For example, if the trainee has applied correct pressure to the wound, the system 100 can cause the wound simulator to stop emitting simulated blood. In some cases, the system 100 can increase the bleeding from the simulator, for example, if the trainee applies the wrong pressure (e.g., pressing hard enough on the wound to cause further bleeding or not hard enough to stop bleeding).

Other variations of the task monitoring system 100 are also possible. For example, while embodiments above have been described in terms training methods for hemorrhage control, the task monitoring system 100 can also be used in other situations, such as in other types of simulations, where force needs to be measured during training. For example, embodiments of the task monitoring system 100 could be used to train people in cardiopulmonary resuscitation (CPR) or the Heimlich maneuver. Many other types of applications and simulated activities can be used.

In some embodiments, the task monitoring system 100 can be used during actual treatment of a wound by medical personnel. For example, a pressure sensor may be applied or attached to a compression bandage or dressing. During actual treatment, the system 100 monitors the pressure sensor and indicates to the medical personnel when incorrect pressure is being applied to the wound.

Other types of interactions (additionally or alternatively) between the task monitoring system 100 and the users are possible in addition to those described above. For example, the user may be able to input data into or control the task monitoring system 100 through another device, such as a keyboard, mouse, or remote control.

In some embodiments, the task monitoring system 100 can be implemented with one or more computing devices, such as several interconnected devices. Thus, each of the components depicted in the task monitoring system 100 can include hardware and/or software for performing various features.

In many embodiments, the task monitoring system 100 may be configured differently than illustrated in the figures. For example, various functionalities provided by the illustrated modules can be combined, rearranged, added, or deleted. In some embodiments, additional or different processors or modules may perform some or all of the functionalities described with reference to the example embodiment illustrated in the figures above. Many implementation variations are possible.

In some embodiments, the task monitoring system 100 and its components are executed or embodied by one or more computing devices. For example, in some embodiments, a computing device that has components including a central processing unit (CPU), input/output (I/O) components, storage and memory may be used to execute some or all of the processes of the task monitoring system 100. The I/O components can include a display (e.g., a touch screen), a network connection to the network 105, a computer-readable media drive and other I/O devices (e.g., a keyboard, a mouse, speakers, a touch screen, etc.). In some embodiments, the task monitoring system 100 may be configured differently than described above.

Components of the task monitoring system 100 can be stored as one or more executable program modules in the memory of the computing device and/or on other types of non-transitory computer-readable storage media, and the task monitoring system 100 can interact with computing assets over a network or other communication link. In some embodiments, the task monitoring system 100 may have additional components or fewer components than described above.

Each of the processes, methods and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state or process blocks may be omitted in some implementations. The methods and processes described herein are also not limited to any particular sequence, and the blocks or states relating thereto can be performed in other sequences that are appropriate. For example, described tasks or events may be performed in an order other than that specifically disclosed, or multiple tasks may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, act, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y and Z,” unless specifically stated otherwise, is otherwise understood with the context as used in general to convey that an item, term, etc. may be either X, Y or Z. Thus, such conjunctive language is not generally intended to imply that certain embodiments require at least one of X, at least one of Y and at least one of Z to each be present.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein.

The following is claimed:

1. A training system for hemorrhage control, the system comprising:
a wound simulator having a pressure sensor at a wound site; and
a computer software application comprising one or more subroutines configured to: (a) monitor the compression force from the pressure sensor; (b) compare the compression force with a target force; and (c) indicate a deviation from or proximity to the target force based on the comparison.

2. A training system for hemorrhage control, the system comprising:
a wound simulator having a pressure sensor at a wound site; and
a mobile device comprising:
a data port connected to the pressure sensor;
a monitoring module configured to monitor pressure data received on the data port from the pressure sensor; and
a device output configured to provide an indication when the pressure data deviates from a target pressure.

3. The training system of claim 1, wherein the data port is a repurposed audio jack

4. The training system of claim 1, wherein the device output comprises at least one of a display, a speaker, or a vibration device.

5. The training system of claim 1, wherein the indication comprises at least one of a physical cue, an auditory cue, or a visual cue.

6. The training system of claim 1, wherein the mobile device is a smart phone that includes a pressure monitoring application.

7. A training device for hemorrhage control, the training device comprising:
a pressure signal receiver configured to receive pressure data including compression force from a pressure sensor; and
one or more processors configured to:
(a) monitor the compression force from the pressure sensor;
(b) compare the compression force with a target force; and
(c) indicate a deviation from or proximity to the target force based on the comparison.

8. The training device of claim 7, wherein the one or more processors are further configured to:
track a compression time during which the compression force is applied; and
indicate a deviation from a target time based on a comparison of the compression time with the target time.

9. The training device of claim 7, further comprising a device output configured to provide an indication of the deviation.

10. The training device of claim 9, wherein the device output comprises at least one of a display, a speaker, or a vibration device.

11. The training device of claim 9, wherein the indication comprises at least one of a physical cue, an auditory cue, or a visual cue.

12. The training device of claim 7, wherein the training device is a smart phone that includes a pressure monitoring application.

13. The training device of claim 12, wherein the pressure signal receiver is an audio port on the smart phone.

14. The training device of claim 7, wherein the training device is built into a wound simulator.

15. The training device of claim 7, wherein the pressure sensor is external to the training device.

16. A method for training health service providers in hemorrhage control, the method comprising:
receiving wound simulation data that identifies a target force;
receiving, on a computing device, pressure data including a compression force from a pressure sensor;
comparing the compression force with the target force; and
indicating, on the computing device, a deviation from the target force based on the comparison.

17. The method of claim 16, wherein the deviation is indicated via at least one of a physical cue, an auditory cue, or a visual cue.

18. The method of claim 16, wherein computing device comprises a smart phone including a pressure monitoring application.

19. The method of claim 16, further comprising
tracking a compression time during which the compression force is applied; and
indicating a deviation from a target time based on a comparison of the compression time with the target time.

20. A non-transitory computer storage having stored thereon instructions that, when executed by a computer system having computer storage, cause the computer system to perform operations comprising:
receiving wound simulation data that identifies a target force;
receiving pressure data including a compression force from a pressure sensor;
comparing the compression force with the target force; and
indicating a deviation from the target force based on the comparison.

21. The non-transitory computer storage of claim 20, wherein the deviation is indicated via at least one of a physical cue, an auditory cue, or a visual cue.
